(19) United States
(12) Patent Application Publication
(10) Pub. No.: US 2026/0299346 A1
(43) Pub. Date: Oct. 1, 2026

(54) DISPLAY DEVICE

(71) Applicant: InnoLux Corporation, Chu-Nan (TW)

(72) Inventors: Yi-Hsien HSU, Chu-Nan (TW); Chia-Wei YEN, Chu-Nan (TW)

(21) Appl. No.: 19/552,947

(22) Filed: Feb. 27, 2026

(30) Foreign Application Priority Data
Mar. 27, 2025 (CN) 202510375782.5

(51) Int. Cl. G02F 1/1333

(52) U.S. Cl. CPC G02F 1/133325; G02F 1/133314; G02F 1/133317

(57) ABSTRACT

A display device includes a back plate, a display module, a plastic frame, an outer frame, and an exterior member. The back plate includes a side wall. The display module is disposed on the back plate. The plastic frame includes a first part disposed on the side wall and adjacent to an outer surface of the side wall, and a first engaging part connected with the first part. The outer frame includes a second engaging part, a third engaging part, and an extending part connected between the second and third engaging parts, wherein the second engaging part engages with the first engaging part, and the third engaging part engages between the first part and the outer surface. The exterior member is disposed on the outer frame and touches the display module, and covers the outer frame in a top view direction.

### CROSS-REFERENCE TO RELATED APPLICATIONS

This application claims the benefits of the Chinese Patent Application Serial Number 202510375782.5, filed on Mar. 27, 2025, the subject matter of which is incorporated herein by reference.

### BACKGROUND

### Field of the Disclosure

The present disclosure relates to a display device and, more particularly to the technology related to the side structure design of the display device.

### Description of Related Art

Some display devices have exterior members installed at their edges (e.g., the ground side). While these members can provide protection and aesthetic appeal, they often leave a noticeable gap between the exterior members and the display surface, creating a visual discontinuity and affecting the visual integrity of the display device. Furthermore, existing exterior members are often secured to other display device components using screws, which can be difficult to remove and can easily damage the components. While some designs use tape or adhesive to attach exterior members to other display device components, these exterior members cannot be removed and cannot be reused.

Therefore, there is a need to provide an improved display device to alleviate and/or obviate the above problems.

### SUMMARY

The present disclosure provides a display device, which includes a back plate, a plastic frame, an outer frame and an exterior member. The back plate includes a side wall having an outer surface. The display module is disposed on the back plate. The plastic frame includes a first part and a first engaging part, wherein the first part is connected to the first engaging part, the first engaging part is disposed on the side wall, and the first part is disposed adjacent to the outer surface. The outer frame includes a second engaging part, a third engaging part, and an extension part, wherein the extension part is connected between the second engaging part and the third engaging part, the second engaging part and the first engaging part engage with each other, and the third engaging part engages between the first part of the plastic frame and the outer surface of the side wall. The exterior member is disposed on the outer frame and in contact with the display module, wherein the exterior member covers the outer frame in a top view direction.

Other novel features of the disclosure will become more apparent from the following detailed description when taken in conjunction with the accompanying drawings.

### BRIEF DESCRIPTION OF DRAWINGS

FIG. 1A is a front plan view of a display device according to an embodiment of the present disclosure;

FIG. 1B is a back plan view of a display device according to an embodiment of the present disclosure;

FIG. 1C is a cross-sectional view of the display device taken along the line A-A′ in FIG. 1A and FIG. 1B;

FIG. 1D is a cross-sectional view of the display device taken along line B-B′ of FIG. 1A and FIG. 1B;

FIG. 2A to FIG. 2C are schematic diagrams illustrating the assembly process of the display device according to an embodiment of the present disclosure; and

FIG. 3A and FIG. 3B are schematic diagrams illustrating the assembly process of the display device according to another embodiment of the present disclosure.

### DETAILED DESCRIPTION OF EMBODIMENT

Reference will now be made in detail to exemplary embodiments of the present disclosure, examples of which are illustrated in the accompanying drawings. Wherever possible, the same reference numerals are used in the drawings and description to refer to the same or like parts.

Throughout the specification and the appended claims, certain terms may be used to refer to specific components. Those skilled in the art will understand that electronic device manufacturers may refer to the same components by different names. The present disclosure does not intend to distinguish between components that have the same function but have different names. In the following description and claims, words such as “containing” and “comprising” are open-ended words, and should be interpreted as meaning “including but not limited to”.

The terms, such as “about”, “equal to”, “equal” or “same”, “substantially”, or “approximately”, are generally interpreted as within 10% of a given value or range, or as within 5%, 3%, 2%, 1%, or 0.5% of a given value or range.

In the specification and claims, unless otherwise specified, ordinal numbers, such as “first” and “second”, used herein are intended to distinguish elements rather than disclose explicitly or implicitly that names of the elements bear the wording of the ordinal numbers. The ordinal numbers do not imply what order an element and another element are in terms of space, time or steps of a manufacturing method. Thus, what is referred to as a “first element” in the specification may be referred to as a “second element” in the claims.

In the present disclosure, the expressions “the given range is from the first numerical value to the second numerical value” and “the given range falls within the range from the first numerical value to the second numerical value” indicate that the given range includes the first numerical value, the second numerical value, and other numerical values therebetween.

The display device of present disclosure may be applied to various electronic devices, including, but not limited to, light-emitting devices, automation equipment, clamping devices, computing devices, mechanical equipment, drug dispensing equipment, exposure devices, printing devices, three-dimensional printing devices, automotive devices, imaging devices, assembly devices, backlight devices, antenna devices, tiled devices, touch electronic devices, curved electronic devices, or free shape electronic devices. The display device may include, for example, liquid crystal, organic light-emitting diodes (OLEDs), light-emitting diodes, fluorescence, phosphor, other suitable display media, or a combination thereof. The display device may be a non-self-luminous display device or a self-luminous display device. The antenna device may be a liquid crystal antenna device or a non-liquid crystal antenna device. The sensing device may be a sensing device that senses capacitance, light, heat, or ultrasound, but not limited thereto. The tiled device may, for example, include a display tiled device or an antenna tiled device, but not limited thereto. It should be noted that the electronic device may be any combination of the aforementioned arrangements, but not limited thereto. In addition, the electronic device may be a bendable or flexible electronic device. It should be noted that the electronic device may be any combination of the aforementioned arrangements, but not limited thereto. In addition, the appearance of the electronic device may be rectangular, circular, polygonal, a shape with curved edges, or other suitable shapes. The electronic device may have peripheral systems such as a drive system, a control system, a light source system, a shelf system, etc. to support the display device, the antenna device, or the tiled device.

It is noted that, in the following embodiments, without departing from the spirit of the present disclosure, the features in different embodiments may be replaced, reorganized, and mixed to complete other embodiments. As long as the features of the various embodiments do not violate or conflict the spirit of the invention, they may be mixed and matched arbitrarily.

Unless otherwise defined, all terms (including technical and scientific terms) used herein have the same meaning as commonly understood by those skilled in the art to which the present disclosure belongs. It can be understood that these terms, such as those defined in commonly used dictionaries, should be interpreted as having meanings consistent with the background or context of the related technology and the present disclosure, and should not be interpreted in an idealized or overly formal manner, unless otherwise specified in the embodiments of the present disclosure.

In addition, the term “adjacent” in the specification and claims is used to describe mutual proximity, and does not necessarily mean mutual contact.

In addition, the description of “when” or “while” in the present disclosure means “now, before, or after”, etc., and is not limited to occurrence at the same time. In the present disclosure, the similar description of “disposed on” or the like refers to the corresponding positional relationship between the two elements, and does not limit whether there is contact between the two elements, unless specifically limited. Furthermore, when the present disclosure recites multiple effects, if the word “or” is used between the effects, it means that the effects can exist independently, but it does not exclude that multiple effects can exist at the same time.

In the present disclosure, any angle mentioned may have a tolerance of plus or minus 10 degrees. For example, if a first direction is perpendicular to a second direction, the angle between the first and second directions may be between 80 and 100 degrees. If the first direction is parallel to the second direction, the angle between the first and second directions may be between 0 and 10 degrees or minus 10 degrees.

In the present disclosure, the distance, length, width and thickness may be measured using an optical microscope, a rangefinder or a vernier. The distance, length, width and thickness may be measured from a cross-sectional image in an electron microscope, but the present disclosure is not limited thereto.

In addition, to make the description clearer, the directions in the figures will be defined as the X direction, the Y direction, and the Z direction. The Z direction may be the normal direction of the display device 1, or may be considered as the display direction or the main light emitting direction, and is sometimes referred to as the second direction in the description. In addition, the Y direction may be the direction from the sky side to the ground side of the display device 1, and may be considered as a tangent direction of the display device 1, and is sometimes referred to as the first direction in the description. The X direction is a direction perpendicular to the Y direction and the Z direction, but may be another tangent direction. In addition, the negative Z direction may be the top view direction of the display device 1, and is sometimes referred to as the third direction in the description.

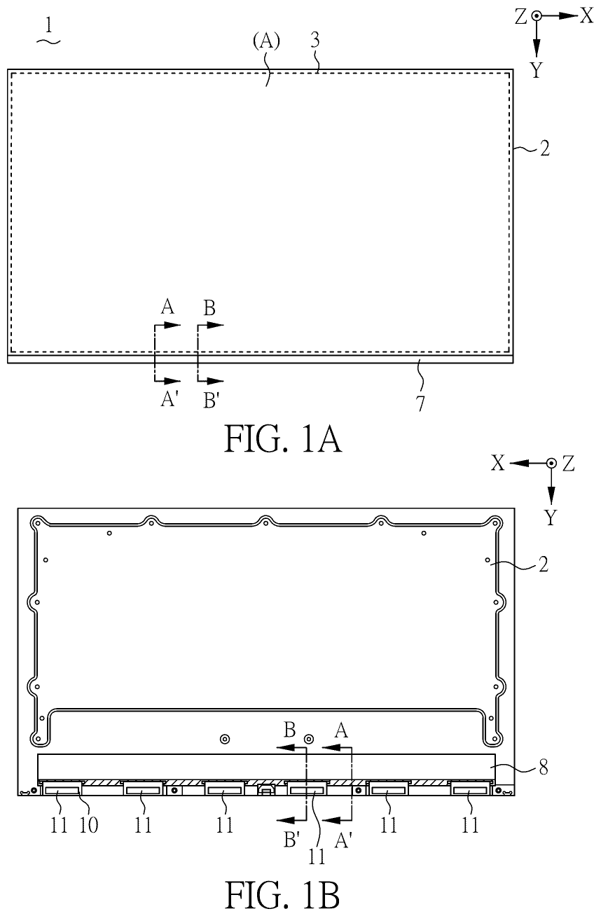

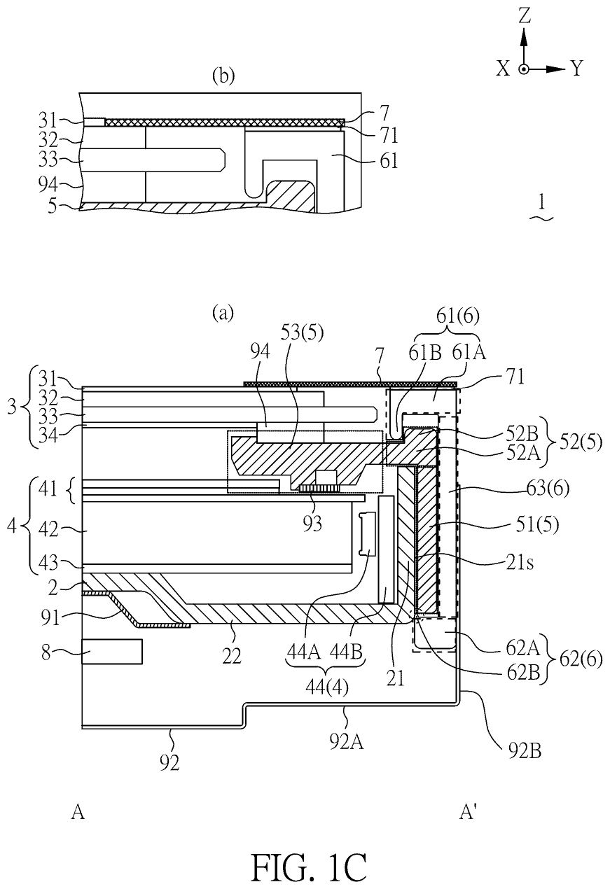

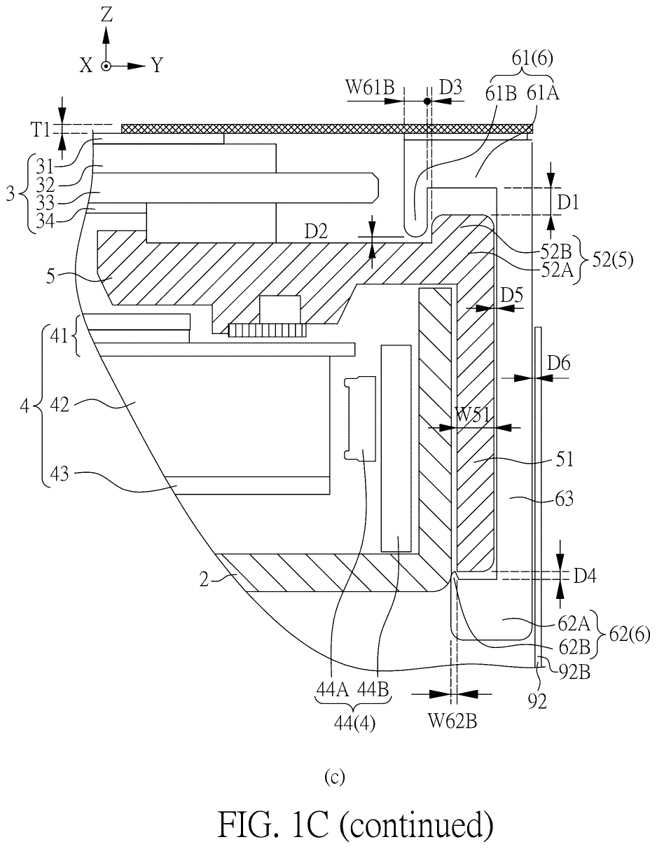

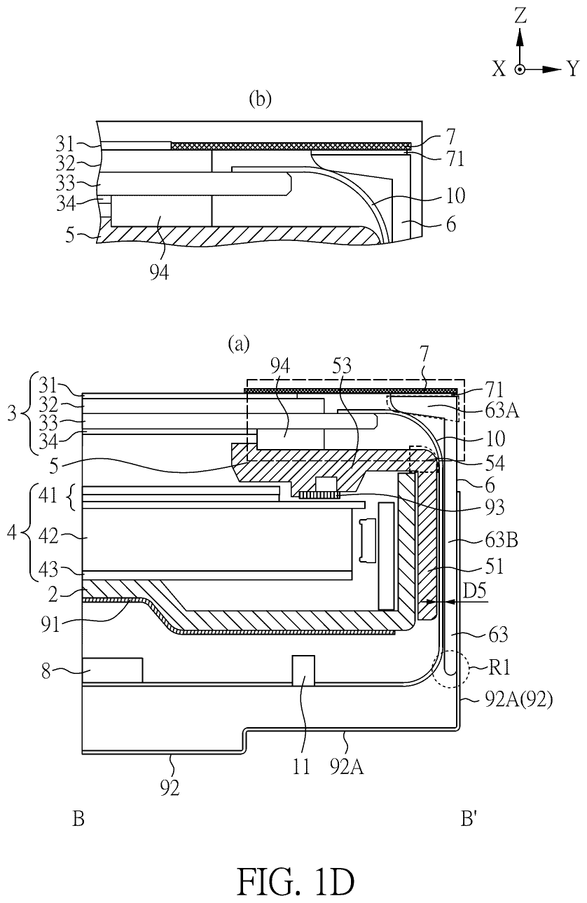

Please refer to FIG. 1A and FIG. 1B, wherein FIG. 1A is a front plan view of a display device 1 according to an embodiment of the present disclosure, and FIG. 1B is a back plan view of a display device 1 according to an embodiment of the present disclosure. As shown in FIG. 1A, the display device 1 may include a back plate 2, a display module 3, and an exterior member 7. The display module 3 may correspond to a display area A. In one embodiment, the display device 1 may further include a backlight module 4. In the Z direction, the display module 3 is disposed on the back plate 2, and the exterior member 7 covers a portion of the display module 3. The exterior member 7 may be, for example, but not limited to, disposed on the ground side of the display device 1 and may, for example, extend in the X direction. In addition, as shown in FIG. 1B, the display device 1 further includes at least one circuit board 10 and at least one driving element 11. In the following description, multiple circuit boards 10 and driving elements 11 are used as examples. The circuit board 10 may be, for example, a flexible printed circuit (FPC) or a printed circuit board (PCB). For ease of explanation, the circuit board 10 is exemplified by an FPC in the description of the present disclosure. The driving element 11 may be, for example, a chip, but it is not limited thereto. The driving element 11 may be disposed on the circuit board 10, and the multiple circuit boards 10 may be arranged at intervals in the X direction. The details of the display device 1 are then described using the cross-sections shown by the lines A-A′ and B-B′ in FIG. 1A and FIG. 1B. The line A-A′ corresponds to an area without the circuit board 10, while the line B-B′ corresponds to an area with the circuit board 10.

FIG. 1C is a cross-sectional view of the display device taken along the line A-A′ in FIG. 1A and FIG. 1B, wherein portion (a) and portion (b) respectively illustrate different configurations of the exterior member 7, and portion (c) is a partially enlarged view corresponding to portion (a) of FIG. 1C. As shown in FIG. 1C, the display device 1 primarily includes a back plate 2, a display module 3, a plastic frame 5, an outer frame 6, and an exterior member 7. The back plate 2 includes a side wall 21 having an outer surface 21s, wherein the outer surface 21s may face the outside of the display device 1. In the Z direction, the display module 3 is disposed on the back plate 2. The plastic frame 5 includes a first part 51 and a first engaging part 52 connected to each other, wherein the first engaging part 52 is disposed on the side wall 21 in the Z direction. In addition, the first part 51 is disposed adjacent to the outer surface 21s. Here, “disposed adjacent to the outer surface 21s” means, for example, that the first part 51 is disposed on one side of the side wall 21 away from the backlight module 4, and there may or may not be other components between the first part 51 and the outer surface 21s. The outer frame 6 includes a second engaging part 61, a third engaging part 62, and an extension part 63, wherein the extension part 63 is connected between the second engaging part 61 and the third engaging part 62. The second engaging part 61 and the first engaging part 52 may be engaged with each other, and the third engaging part 62 may be engaged between the first part 51 of the plastic frame 5 and the outer surface 21s of the side wall 21. Here, “engaged with each other” means, for example, that multiple components are limited to each other through one or more protruding structures, but it is not limited thereto. In the Z direction, the exterior member 7 is disposed on the outer frame 6. The exterior member 7 may contact the display module 3. For example, the exterior member 7 and the display module 3 may contact each other in the Z direction (as shown in the aspect of portion (a)), or they may contact each other in the Y direction (as shown in the aspect of portion (b)). In addition, in the top view direction (for example, in the-Z direction), the exterior member 7 covers the outer frame 6. In addition, in one embodiment, the display device 1 may further include a backlight module 4 and a substrate 8, wherein, in the Z direction, the backlight module 4 may be disposed between the display module 3 and the back plate 2, and the substrate 8 may be disposed below the back plate 2.

The detailed features of each component will be described next. Regarding the back plate 2, in one embodiment, the back plate 2 may further include a bottom 22, wherein the bottom 22 may be connected to the side wall 21. The side wall 21 and the bottom 22 may extend in different directions, for example, the side wall 21 may extend along the Z direction, and the bottom 22 may extend along the Y direction or the negative Y direction. The outer surface 21s of the side wall 21 may be, for example, one side of the side wall 21 away from the backlight module 4, while it is not limited thereto. In addition, in the Z direction, an insulating layer 91 may be provided below the bottom 22 of the back plate 2, and the insulating layer 91 may be in contact with at least a portion of the bottom 22. In one embodiment, the material of the insulating layer 91 may include polyethylene terephthalate (PET) or other suitable materials, while is not limited thereto.

Regarding the display module 3, in one embodiment, the display module 3 may include an upper polarizing layer 31, an upper glass substrate 32, a lower glass substrate 33, and a lower polarizing layer 34. In the Z direction, the lower glass substrate 33 may be disposed on the lower polarizing layer 34, the upper glass substrate 32 may be disposed on the lower glass substrate 33, and the upper polarizing layer 31 may be disposed on the upper glass substrate 32. In addition, a liquid crystal layer (not shown) may be disposed between the lower glass substrate 33 and the upper glass substrate 32. In one embodiment, the upper polarizing layer 31 and the upper glass substrate 32 may be used to form a color filter layer, and the lower glass substrate 33, the lower polarizing layer 34, and the liquid crystal layer may be used to form a liquid crystal array structure. In another embodiment, the display module 3 may be a self-luminous display module. In this case, a light-emitting layer (not shown) may be disposed between the lower glass substrate 33 and the upper glass substrate 32. The light-emitting layer may include, for example, light-emitting diodes (LEDs) or organic light-emitting diodes (OLEDs), quantum dots, and active elements (such as TFTs), but it is not limited thereto.

Regarding the backlight module 4, in one embodiment, the backlight module 4 may include an optical film set 41, a light guide plate 42, a reflective sheet 43, and a light source 44. In the Z direction, the light guide plate 42 may be disposed on the reflective sheet 43, and the optical film set 41 may be disposed on the light guide plate 42 and, in the Y direction, the light source 44 may be disposed adjacent to the light guide plate 42. The optical film set 41 may include at least one optical film or multiple optical films, and the multiple optical films may be stacked in the Z direction. The light source 44 may include at least one light-emitting unit 44A and a light source substrate 44B. The at least one light-emitting unit 44A may be disposed on one side of the light source substrate 44B adjacent to the light guide plate 42. The light source substrate 44B may be, for example, a circuit board of the light source 44, such as a printed circuit board (PCB) or a flexible circuit board (FPC). The light source substrate 44B may be disposed adjacent to an inner surface (not shown) of the side wall 21, wherein the inner surface is opposite to the outer surface 21s and adjacent to the surface of the light source 44.

Regarding the plastic frame 5, in one embodiment, the plastic frame 5 may include a first part 51, a first engaging part 52, and a second part 53, wherein the first engaging part 52 is connected between the first part 51 and the second part 53. The first part 51 and the second part 53 may extend in different directions. For example, the first part 51 may extend from the first engaging part 52 in a top view direction (−Z), and the second part 53 may extend from the first engaging part 52 in a negative Y direction (−Y). In one embodiment, in the Z direction, at least a portion of the second part 53 may be disposed between the bottom 22 of the back plate 2 and the display module 3. The first engaging part 52 may include a first horizontal structure 52A. In the cross-sectional view of FIG. 1C, the first horizontal structure 52A may extend along a first direction (Y). The first engaging part 52 may further include a first protruding structure 52B. In the cross-sectional view, the first protruding structure 52B extends from the first horizontal structure 52A along a second direction (Z), wherein the first direction (Y) is different from the second direction (Z).

Regarding the outer frame 6, in one embodiment, the extension part 63 may extend in the normal direction (Z), and the second engaging part 61 may be connected to the top end of the extension part 63 in the normal direction (Z), and the third engaging part 62 may be connected to the bottom end of the extension part 62 in the normal direction (Z). In addition, in the Y direction, the second engaging part 61 may be adjacent to the display module 3, and the third engaging part 62 may be adjacent to the back plate 2. The second engaging part 61 may include a second horizontal structure 61A and a second protruding structure 61B, wherein the second horizontal structure 61A may be parallel to the first horizontal structure 52A, for example, both extending along the second direction (Y). The second protruding structure 61B may extend from the second horizontal structure 61A along a third direction (−Z), wherein the third direction (−Z) is opposite to the second direction (Z). Furthermore, the third engaging part 62 may include a third horizontal structure 62A and a third protruding structure 62B. The third protruding structure 62B extends from the third horizontal structure 62A along the second direction (Z). In one embodiment, in the first direction (Y), the first part 51 of the plastic frame 5 may have a width W51, and the third protruding structure 62B may have a width W62B. The width W62B of the third protruding structure 62B is smaller than the width W51 of the first part 51 (W62B<W51). In one embodiment, the width W62B of the third protruding structure 62B may be between 0.05 and 0.3 mm (0.05 mm≤W62B≤0.3 mm), but it is not limited thereto. Furthermore, in one embodiment, the second protruding structure 61B may have a width W61B in the first direction (Y). The width W61B of the second protruding structure 61B may be between 0.5 and 1 mm (0.5 mm≤W61B≤1 mm), but it is not limited thereto. It should be noted that the aforementioned “width” may be defined as the maximum distance between opposite sides of a single component in a direction perpendicular to the normal line (e.g., the Z direction). In one embodiment, the material of the outer frame 6 includes various suitable elastic materials, such as plastic or other suitable materials, but it is not limited thereto.

Regarding the exterior member 7, in one embodiment, the material of the exterior member 7 may include a suitable metal or alloy, or may also include plastic, but it is not limited thereto. In one embodiment, the exterior member 7 has a thickness T1 in the Z direction. The thickness T1 may be between 0.05 and 0.3 mm (0.05 mm≤T1≤0.3 mm), but it is not limited thereto. It should be noted that the aforementioned “thickness” may be defined as the maximum distance between opposite sides of a single component in the normal direction (Z).

Regarding the substrate 8, in one embodiment, the substrate 8 may be, for example, a printed circuit board (PCB), but it is not limited thereto. In one embodiment, an insulating layer 92 may be disposed below the substrate 8, and the insulating layer 92 may contact at least a portion of the substrate 8 (not shown). The insulating layer 92 may have region 92A and region 92B connected to each other, wherein 92A extends along the Y direction and 92B extends along the Z direction. In one embodiment, the material of the insulating layer 92 is applicable to the description of the insulating layer 91, but it is not limited thereto.

Next, the configuration relationship between the components will be described. In one embodiment, in the Z direction, the back plate 2 is disposed on the substrate 8. The backlight module 4 is disposed on the bottom 22 of the back plate 2. The second part 53 of the plastic frame 5 is disposed on the optical film set 41 and the side wall 21 of the back plate 2, and the plastic frame 5 may partially overlap with the optical film set 41 (for example, not completely overlap). The lower polarizing layer 34 of the display module 3 is disposed on the second part 53 of the plastic frame 5. The second engaging part 61 of the outer frame 6 may be disposed on the plastic frame 5. The exterior member 7 may be disposed on the display module 3 and the second engaging part 61 of the outer frame 6. For example, the exterior member 7 may be in contact with the upper polarizing layer 31 of the display module 3 in the Z direction, and the exterior member 7 may be attached to the second engaging part 61 in the Z direction through an adhesive layer 71, while it is not limited thereto. In addition, a rubber member 93 may be disposed between the second part 53 of the plastic frame 5 and the optical film set 41, and a buffer member 94 may be disposed between the lower polarizing layer 34 of the display module 3 and the second part 53 of the plastic frame 5. The material of the buffer member 94 may include polyurethane (PU), for example, but it is not limited thereto.

In the Y direction, in one embodiment, the light source 44 may be disposed between the light guide plate 42 and the side wall 21, and the first part 51 of the plastic frame 5 may be disposed between the side wall 21 and the extension part 63 of the outer frame 6. Furthermore, in one embodiment, the extension part 63 of the outer frame 6 may also be disposed between the first part 51 of the plastic frame 5 and the region 92B of the insulating layer 92.

Next, the details of the engagement between the outer frame 6 and the plastic frame 5 will be described. In one embodiment, in the Z direction, the second horizontal structure 61A of the second engaging part 61 may be disposed on the first protruding structure 52B of the first engaging part 52. In a cross-sectional view (e.g., −Z), the second protruding structure 61B of the second engaging part 61 may be disposed on the first horizontal structure 52A of the first engaging part 52. Thus, the second protruding structure 61B, the second horizontal structure 61A, and the extension part 63 may surround the first protruding structure 52B. Furthermore, in the Z direction, the first part 51 of the plastic frame 5 may be disposed on the third horizontal structure 62A of the third engaging part 62. In the Y direction, the third protruding structure 62B of the third engaging part 62 may be disposed between the outer surface 21s of the side wall 21 and the first part 51 of the plastic frame 5. Thus, the third protruding structure 62B, the third horizontal structure 62A, and the extension part 63 may partially surround the first part 51 of the plastic frame 5. As a result, the first engaging part 52 and the second engaging part 61 may engage with each other, and the third protruding structure 62B of the third engaging part 62 may engage between the first part 51 and the outer surface 21s of the side wall 21, so that the plastic frame 5 and the outer frame 6 may engage or limit with each other.

Furthermore, referring to portion (b) and portion (c) of FIG. 1C, in one embodiment, a distance D1 may be provided between the first protruding structure 52B and the second horizontal structure 61A in the Z direction. The distance D1 may be between 0.2 and 0.5 mm (0.2 mm≤D1≤0.5 mm), or between 0.3 and 0.4 mm (0.3 mm≤D1≤0.4 mm), but it is not limited thereto. It should be noted that “a distance between the first object and the second object” refers to the minimum distance between the first object and the second object. In one embodiment, in the Z direction (normal direction), a distance D2 may be provided between the second protruding structure 61B and the first horizontal structure 52A. The distance D2 may be between 0 and 0.2 mm (0 mm≤D1≤0.2 mm), or between 0.1 and 0.2 mm (0.1 mm≤D1≤0.2 mm), but it is not limited thereto. In one embodiment, in the Y direction, a distance D3 may be provided between the second protruding structure 61B and the first protruding structure 52B. The distance D3 may be between 0 and 0.2 mm (0 mm≤D3≤0.2 mm), or between 0.1 and 0.2 mm (0.1 mm≤D3≤0.2 mm), but it is not limited thereto. In one embodiment, a distance D4 is defined between the first part 51 of the plastic frame 5 and the third horizontal structure 62A in the Z direction. Thr distance D4 may be between 0 and 0.2 mm (0 mm≤D4≤0.2 mm), or between 0.1 and 0.2 mm (0.1 mm≤D4≤0.2 mm), but it is not limited thereto. Furthermore, in one embodiment, a distance D5 between the first part 51 of the plastic frame 5 and the extension part 63 of the outer frame 6 in the Y direction may be between 0.03 and 0.5 mm (0.03 mm≤D5≤0.5 mm), or between 0.04 and 0.1 mm (0.04 mm≤D5≤0.1 mm), but it is not limited thereto. In addition, in one embodiment, in the Y direction, the distance D6 between the extension part 63 and the region 92B of the insulating layer 92 may be between 0 and 0.2 mm (0 mm≤D6≤0.2 mm), or may be between 0.1 and 0.2 mm (0.1 mm≤D6≤0.2 mm), while it is not limited thereto.

In addition, in another embodiment, the exterior member 7 may also be adjusted to be arranged on the upper glass substrate 32 of the display module 3 and the second engaging part 61 of the outer frame 6 in the Z direction, wherein the exterior member 7 and the upper glass substrate 32 may be in contact in the Z direction, and the exterior member 7 and the upper polarizing layer 31 may be in contact in the Y direction (as in the state of portion (b)), while it is not limited thereto.

FIG. 1D is a cross-sectional view of the display device taken along line B-B′ of FIG. 1A and FIG. 1B, showing the cross-sectional structure of the area having the flexible substrate 11, wherein portion (a) and portion (b) respectively illustrate different configurations of the exterior member 7. FIG. 1D is generally applicable to the description of FIG. 1C, and thus the following description will focus on the differences.

As shown in FIG. 1D, the display device 1 may further include a circuit board 10 and a driving element 11. The driving element 11 may be disposed on the circuit board 10. In one embodiment, at least one conductive electrode may be disposed on a surface of the lower glass substrate 33. One end of the circuit board 10 may be electrically connected to the conductive electrode. The circuit board 10 may extend to be below the bottom 22 of the back plate 2 (e.g., as viewed in the Z direction) through the gap between the first part 51 of the plastic frame 5 and the extension part 63 of the outer frame 6, so that the driving element 11 may be disposed below the back plate 2 and, furthermore, the flexible circuit board 10 may also be electrically connected to the substrate 8, but it is not limited thereto. As a result, a COF (Chip On Film) packaging structure may be formed. In one embodiment, the driving element 11 may be, for example, a chip, but it is not limited thereto. In addition, in response to the configuration of the circuit board 10, in the cross-section of FIG. 1D, the outer frame 6 may have a first extension part 63A and a second extension part 63B, wherein the first extension part 63A may extend in the Y direction or the negative Y direction, the second extension part 63B may extend in the Z direction or the negative Z direction, and the first extension part 63A may be connected to the second extension part 63B.

In one embodiment, in order to accommodate the circuit board 10, a distance D5 is defined between the first part 51 of the plastic frame 5 and the second extension part 63B of the outer frame 6 in the Y direction. The distance D5 may be between 0.25 and 0.5 mm (0.25 mm≤D5≤0.5 mm), or between 0.25 and 0.3 mm (0.25 mm≤D5≤0.3 mm), while it is not limited thereto. As a result, it is able to reduce the chance of surface damage to the circuit board 10 due to insufficient space between the plastic frame 5 and the outer frame 6, while it is not limited thereto.

In one embodiment, the contact between the exterior member 7 and the upper polarizing layer 31 and/or the upper glass substrate 32 is a detachable contact, that is, no fixed connection is required, thereby facilitating repeated assembly and disassembly between the outer frame 6 and the plastic frame 5.

In one embodiment, a gap may be provided between the circuit board 10 and the first extension part 63A of the outer frame 6 so that the two are not easily in contact or rubbed against each other, thereby reducing the chance of the outer frame 6 damaging the surface of the circuit board 10, while it is not limited thereto.

In one embodiment, since the bottom of the second extension part 63B of the outer frame 6 (for example, when viewed in the Z direction) may come into touch with the circuit board 10 in some cases, the bottom of the second extension part 63B in the cross section may be designed to have an arc angle R1, but it is not limited thereto.

Accordingly, the structure of the display device 1 can be understood.

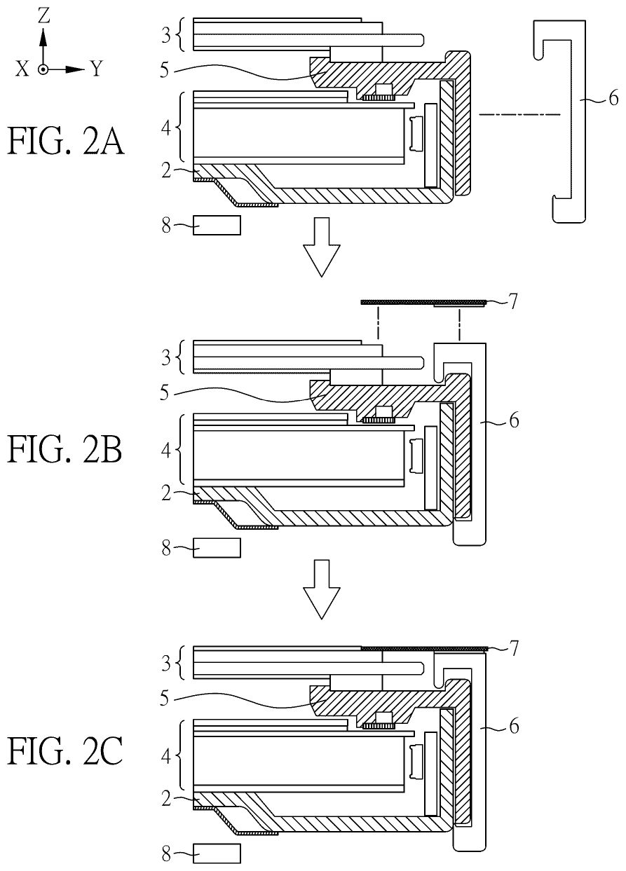

Next, the assembly process of the outer frame 6 and the exterior member 7 will be described. FIG. 2A to FIG. 2C are schematic diagrams illustrating the assembly process of the display device 1 according to an embodiment of the present disclosure, and please refer to FIG. 1A to FIG. 1D for further reference. For ease of explanation, FIG. 2A to FIG. 2C are exemplified by the structure of FIG. 1C, and the assembly process of FIG. 1D may be inferred therefrom.

As shown in FIG. 2A, the outer frame 6 may first be engaged with the plastic frame 5. The engagement method may be referred to the description in the previous paragraph. Then, as shown in FIG. 2B, after the outer frame 6 is engaged with the plastic frame 5, the exterior member 7 may be disposed on the upper polarizing layer 31 and the second horizontal structure 61A of the outer frame 6. In this way, the assembly of the outer frame 6 and the exterior member 7 may be completed, as shown in FIG. 2C. In one embodiment, the advantages of installing the exterior member 7 after installing the outer frame 6 include more accurate assembly of the exterior member to reduce the gap between the exterior member 7 and the upper polarizing layer 31, but it is not limited thereto.

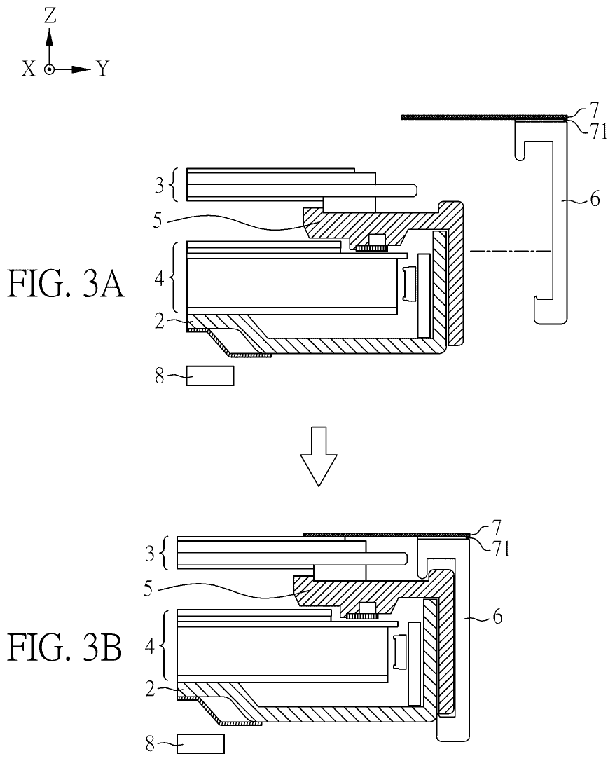

FIG. 3A and FIG. 3B are schematic diagrams illustrating the assembly process of the display device 1 according to another embodiment of the present disclosure, and please refer to FIG. 1A to FIG. 2C for further reference. For ease of explanation, FIG. 3A and FIG. 3B are exemplified by the structure of FIG. 1C, and the assembly process of FIG. 1D may be inferred therefrom.

As shown in FIG. 3A, the outer frame 6 and the exterior member 7 may be pre-bonded together. After bonding, the outer frame 6 may be engaged with the plastic frame 5. As a result, the assembly of the outer frame 6 and the exterior member 7 may be completed, as shown in FIG. 3B. This design has the advantage of facilitating repeated assembly of the outer frame 6 and the exterior member 7.

Accordingly, the features of the display device 1 of the present disclosure can be understood.

As can be seen from this, the display device 1 of the present disclosure has specially designed structural features that may reduce the sense of discontinuity when assembling the exterior member 7, thereby improving the visual integrity. Alternatively, the exterior member 7 may be reassembled, which may reduce the cost of the product.

In one embodiment, the present disclosure may determine whether a product in contention falls within the protection scope of the present disclosure at least by the presence or absence of components, component configurations and/or physical appearance observation of the product, while it is not limited thereto. Furthermore, the physical appearance observation may be performed, for example, with the naked eyes in combination with a tool, or the physical appearance observation may be achieved by using an optical microscope or a scanning microscope, but not limited thereto.

The features of the various embodiments of the present disclosure may be mixed and matched as desired as long as they do not violate the spirit of the invention or conflict with each other.

The aforementioned specific embodiments should be construed as merely illustrative, and not limiting the rest of the present disclosure in any way.

1. A display device, comprising:
a back plate including a side wall having an outer surface;
a display module disposed on the back plate;
a plastic frame including a first part and a first engaging part, wherein the first part is connected to the first engaging part, the first engaging part is disposed on the side wall, and the first part is disposed adjacent to the outer surface;
an outer frame including a second engaging part, a third engaging part, and an extension part, wherein the extension part is connected between the second engaging part and the third engaging part, the second engaging part and the first engaging part engage with each other, and the third engaging part engages between the first part of the plastic frame and the outer surface of the side wall; and
an exterior member disposed on the outer frame and in contact with the display module, wherein the exterior member covers the outer frame in a top view direction.

2. The display device as claimed in claim 1, wherein the third engaging part includes a third horizontal structure and a third protruding structure, the third protruding structure extends from the third horizontal structure along a second direction and, in a first direction, a width of the third protruding structure is smaller than a width of the first part of the plastic frame.

3. The display device as claimed in claim 2, wherein, in the first direction, the width of the third protruding structure is between 0.05 mm and 0.3 mm.

4. The display device as claimed in claim 1, wherein the first engaging part includes a first horizontal structure, the second engaging part includes a second horizontal structure and, in a cross-sectional view, the first horizontal structure extends along a first direction and the second horizontal structure is parallel to the first horizontal structure.

5. The display device as claimed in claim 4, wherein the first engaging part further includes a first protruding structure extending from the first horizontal structure along a second direction, and the second engaging part further includes a second protruding structure extending from the second horizontal structure along a third direction, where the second direction is different from the first direction and the third direction is opposite to the second direction.

6. The display device as claimed in claim 5, wherein a distance between the first protruding structure and the second horizontal structure in a normal direction is between 0.2 mm and 0.5 mm.

7. The display device as claimed in claim 5, wherein a distance between the second protruding structure and the first horizontal structure in a normal direction is between 0 mm and 0.2 mm.

8. The display device as claimed in claim 1, wherein the back plate further includes a bottom connected to the side wall.

9. The display device as claimed in claim 1, wherein the plastic frame further includes a second part connected to the first engaging part, and the second part is disposed between the bottom and the display module.

10. The display device as claimed in claim 1, wherein a thickness of the exterior member is between 0.05 mm and 0.3 mm.

11. The display device as claimed in claim 8, further comprising a backlight module and a substrate, wherein the backlight module is disposed between the display module and the back plate, and the substrate is disposed below the back plate.

12. The display device as claimed in claim 9, wherein the side wall and the bottom extend in different directions, and the outer surface of the side wall is one side of the sidewall facing away from the backlight module.

13. The display device as claimed in claim 8, wherein a first insulating layer is disposed below the bottom of the back plate and is in contact with at least a portion of the bottom.

14. The display device as claimed in claim 11, wherein a second insulating layer is disposed below the substrate and is in contact with at least a portion of the substrate, and the second insulating layer has a first region and a second region connected to each other and extending in different directions.

15. The display device as claimed in claim 7, wherein a width of the second protruding structure is between 0.5 mm and 1 mm.

16. The display device as claimed in claim 5, wherein a distance between the second protruding structure and the first protruding structure is between 0 mm and 0.2 mm.

17. The display device as claimed in claim 2, wherein, in a normal direction, a distance between the first part of the plastic frame and the third horizontal structure is between 0 mm and 0.2 mm.

18. The display device as claimed in claim 1, wherein a distance between the first part of the plastic frame and the extension part of the outer frame is between 0.03 mm and 0.5 mm.

19. The display device as claimed in claim 14, wherein the extension part of the outer frame is disposed between the first part of the plastic frame and the second region of the second insulating layer, and a distance between the extension part and the second region of the second insulating layer is between 0 mm and 0.2 mm.

20. The display device as claimed in claim 8, further comprising a circuit board and a driving element disposed on the circuit board, wherein the circuit board extends to be below the bottom of the back plate through a gap between the first part of the plastic frame and the extension part of the outer frame.
